(19) United States
(12) Patent Application Publication
(10) Pub. No.: US 2025/0004868 A1
(43) Pub. Date: Jan. 2, 2025

(54) DETECTION OF ANOMALOUS SYSTEM BEHAVIOR

(71) Applicant: International Business Machines Corporation, Armonk, NY (US)

(72) Inventors: Erik Richter Altman, Danbury, CT (US); Benjamin P. Segal, Hyde Park, NY (US); Donald William Schmidt, Stone Ridge, NY (US)

(73) Assignee: International Business Machines Corporation, Armonk, NY (US)

(21) Appl. No.: 18/217,281

(22) Filed: Jun. 30, 2023

(51) Int. Cl. G06F 11/07; G06F 11/14; G06F 11/34

(52) U.S. Cl. CPC G06F 11/0769; G06F 11/142; G06F 11/1469; G06F 11/3428

(57) ABSTRACT

An embodiment establishes a system behavior database based at least in part on behavior data received from a system, wherein the system behavior database comprises a set of historical observations of behavior of the system. The embodiment samples current behavior data from the system. The embodiment generates a current observation based on the current behavior data that was sampled. The embodiment compares the current observation to each historical observation of the set of historical observations to determine a divergence between the current observation and each historical observation. The embodiment compares the divergence to a divergence threshold, and upon a determination that the divergence exceeds the divergence threshold, detects an anomaly in the system, updates the set of historical observations to include the current observation as a new historical observation, and performs a responsive action within the system based on the detected anomaly.

### BACKGROUND

The present invention relates generally to system monitoring. More particularly, the present invention relates to a method, system, and computer program for detection of anomalous behavior in a system.

An anomalous event is an event that is inconsistent with or deviating from normal, routine, expected system behavior. An anomalous event may signal a variety of problems in any system. As such, robust, fast detection of anomalies is important so that potential issues may be addressed before those potential issues cascade to create larger problems. Anomaly detector systems may enable identification of routine and unexpected events that may compromise performance and/or security within a time frame in order to prevent or reduce the impact and consequences of those events to the functioning of a system.

Kullback-Leibler (KL) divergence, also known as relative entropy, is a measure of the difference between two probability distributions. A probability distribution describes the likelihood of different events or outcomes occurring in a given set or domain. In a probability distribution, each event is associated with a probability value that represents the likelihood of that event occurring. Probability distributions of events occurring over a system may provide valuable insights into system behavior, which thereby may enable detection of anomalies, statistical analysis, capacity planning, optimization, and/or security monitoring. Accordingly, analysis of probability distributions of events occurring over a system enables effective system management and may help to ensure the stability, security, and/or performance of system infrastructure.

### SUMMARY

The illustrative embodiments provide for detection of anomalous system behavior. An embodiment includes establishing a system performance database based at least in part on performance data received from a computer system. The system performance database includes a set of historical observations of performance of the computer system. The embodiment also includes sampling current performance data from the computer system. The embodiment also includes generating a current observation based on the current performance data that was sampled. The embodiment also includes comparing the current observation to each historical observation of the set of historical observations to determine a divergence between the current observation and each historical observation. The embodiment also includes comparing the divergence to a divergence threshold, and upon a determination that the divergence exceeds the divergence threshold, detecting an anomaly in the computer system. The embodiment also includes updating the set of historical observations to include the current observation as a new historical observation The embodiment also includes performing a responsive action within the computer system based on the detected anomaly. Other embodiments of this aspect include corresponding computer systems, apparatus, and computer programs recorded on one or more computer storage devices, each configured to perform the actions of the embodiment.

An embodiment includes a computer usable program product. The computer usable program product includes a computer-readable storage medium, and program instructions stored on the storage medium.

An embodiment includes a computer system. The computer system includes a processor, a computer-readable memory, and a computer-readable storage medium, and program instructions stored on the storage medium for execution by the processor via the memory.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of the illustrative embodiments when read in conjunction with the accompanying drawings, wherein:

FIG. 1 depicts a block diagram of a computing environment in accordance with an illustrative embodiment;

FIG. 2A depicts a block diagram of example computer system environment in accordance with an illustrative embodiment;

FIG. 2B depicts a block diagram of an anomaly detector module in accordance with an illustrative embodiment;

FIG. 3A depicts an example abstracted model of a data structure storing a probability distribution of events in accordance with an illustrative embodiment;

FIG. 3B depicts example abstracted models of a data structures storing a set of historical probability distributions a current probability distribution in accordance with an illustrative embodiment;

FIG. 4A depicts an example abstracted model for of a process for determining a multivariable probability distribution of events in accordance with an illustrative embodiment;

FIG. 4B depicts an example abstracted model for of a process for determining a multivariable probability distribution of events in accordance with an illustrated embodiment;

FIG. 5 depicts a block diagram of an example abstracted model for updating a section of memory containing the range of values in a probability distribution in accordance with an illustrative embodiment;

FIG. 6 depicts a block diagram of an example abstracted model of a section of memory partitioned to account for one or more missing data samples in accordance with an illustrative embodiments;

FIG. 7 depicts a graph of an example process for detecting anomalous behavior in a computer system;

FIG. 8 depicts a graph of an example process for detecting anomalous behavior in a computer system;

FIG. 9 depicts a graph illustrating growth of unique system behaviors detected by an example process for detecting anomalous behavior in a computer system;

FIG. 10 depicts a graph illustrating growth of unique system behaviors detected by an example process for detecting anomalous behavior in a computer system; and

FIG. 11 depicts a flowchart of an example process for detection of an anomalous system behavior.

### DETAILED DESCRIPTION

Anomaly detection is important for understanding the behavior of any type of system. Further, anomaly detection is important for ensuring the proper functioning of computer systems as well as for many other domains such as traffic flows, prices in markets (e.g. for arbitrage), quality-inspection systems, and even the search for extra-terrestrial intelligence. Anomaly detection refers to the identification of rare items, events or observations which deviate significantly from the majority of the data and do not conform to a usual, expected, normal behavior. Accordingly, anomaly detection enables the identification of abnormal or unexpected behavior of a system, as well as enables performing proactive responses to maintain optimal performance, stability, and security of a system. In the context of computer systems, ongoing operation of the computer system may be continuously monitored and compared against historical behavior to determine whether the system is exhibiting anomalous behavior. Types of observed behavior of the system may include, but are not limited to, whether the system is running slower than usual, whether the system is running faster than usual, whether the system is reading more files than usual, whether the system is writing more files than usual, etc. Causes of anomalous behavior may include, but are not limited to, a misconfigured system component, a bug within a program or combination of programs, a lack of enough available resources to carry out operations, a ransomware attack, unauthorized access to the system, etc.

A mainframe computer system (also referred to as a “mainframe”) is a specific type of computer system that may be characterized by the system's robustness, scalability, and capability to reliably and efficiently handle large-scale enterprise workloads. Accordingly, mainframes may be especially well suited in processing large volumes of data, running complex transactional workloads, and supporting multiple virtualized environments. The biggest workload of a mainframe typically includes transaction-based operations. Mainframes are typically used in applications across various industries, including but not limited to, e-commerce, finance, banking, healthcare, and government. Mainframes may possess specialized operating systems and software designed to optimize their performance and manage complex workload requirements. Further, mainframes typically have built-in redundancy features, advanced fault tolerance mechanisms, and extensive connectivity options to integrate with diverse systems and networks. Although a mainframe computer system is described, anomaly detection likewise important for and may be implemented on any type of computer system, including but not limited to, a super computer, mini computer, workstation computer, personal computer, server computer, analog computer, digital computer, hybrid computer, tablet, smartphone, personal digital assistant (PDA) and any other system and/or device that handles information and/or processes data.

Computer system monitoring has been performed by a number of different monitoring systems and methods. One approach to computer system monitoring includes the utilization of KL divergence to examine computer system behavior, and accordingly, to detect an anomaly or anomalies within said computer system behavior. Accordingly, KL divergence may be used to compare the probability distributions of monitored variables and/or events occurring over a computer system.

Previous techniques for detecting anomalies in computer systems are notorious for providing a high percentage of false-positive anomaly detections. Previous attempts for detecting anomalies in systems include geometric mean entropy based detection as well as a basic KL divergence based detection. In comparison to previous attempts, embodiments of the presently disclosed process provide a much less noisy signal with respect to detecting anomalies, meaning that fewer false positives are erroneously detected. It is contemplated that a noisy signal as a result of a high-percentage of false-positive detection of anomalous behavior may cause an observer of the system behavior to be less weary of detected anomalies in the system.

Further, false-positive detections of anomalies may result in an unnecessary waste of computer resources. It is contemplated that responses to detected anomalies in a computer system may require computationally expensive operations to be performed. Embodiments of the presently disclosed process provide for fewer false-positives, thereby increasing the efficient utilization of computer resources by saving computer resources that otherwise would be wasted on actuating responses to false-positive indications of potential anomalies.

Further, there exist a number of other deficiencies associated with current techniques of anomaly detection. One deficiency of a basic KL divergence based technique is that basic KL divergence can only be applied to a single variable. Accordingly, it would be highly inefficient to utilize single variable comparison at a time, especially in high-dimensional data.

Further, current techniques do not provide any mechanism for determining correlation between multiple monitored variables. For example, it may be the case that divergence for a first monitored variable is not significant, and the divergence for a second monitored variable is also not significant, which would ordinarily not alert to the presence of an anomaly. However, in the same scenario, it may be also the case that an anomalous event is occurring, where even though neither one of the divergences are individually significant, if both those variables historically exhibit a correlation pattern, and in a current observation they are out-of-correlation with each other.

The process disclosed provides significant advantages over previous existing anomaly detection techniques, as described further herein. One advantage of the presently disclosed process compared to previous existing techniques includes multivariable anomaly detection process. Accordingly, the process is able to detect an anomaly across multiple variables instead of a single variable. Further, the multivariable anomaly detection process enables anomaly detection across multiple variables in linear time. Instead of sequentially comparing one variable to another variable across a computer system, the process enables comparison of multiple variables to multiple other variables in a single iteration. Accordingly, the multivariable anomaly detection aspect of the process provides a significant improvement to the speed and computer resource utilization of the underlying computer technology utilized to perform the disclosed process.

Another advantage of the presently disclosed process includes the ability to detect anomalies arising from correlation patterns between variables. For example, it may be the case that two or more variables independently do not exhibit anomalous behavior, however, the relationship between those two or more variables may indicate that those two or more variables are out of correlation with each other, which may indicate a potential anomaly. Accordingly, the correlation-based anomaly detection aspect of the disclosed process provides a significant improvement to computer system security, wherein previously existing techniques might otherwise miss that two variables are out of correlation with each other, which may cause an anomalous event to go unnoticed.

Another advantage of the presently disclosed process compared to previous existing techniques includes the enablement of dynamic range for probability distribution of events.

Another advantage of the presently disclosed process compared to previous existing techniques includes accounting for missing data samples that may not have been obtained during sampling data from a computer system while monitoring the behavior of the system.

The present disclosure addresses the deficiencies described above by providing a process (as well as a system, method, machine-readable medium, etc.) that includes a multivariable divergence-based technique to detect an anomaly in a computer system behavior. Accordingly, the illustrative embodiments provide for detection of anomalous computer system behavior. An anomaly as referred to herein is an indication of unusual system behavior, wherein unusual system behavior includes system behavior that is inconsistent with expected system behavior that has been historically observed. Embodiments disclosed herein describe the system as a computer system; however, use of this example is not intended to be limiting, but is instead used for descriptive purposes only. Instead, the system can include any type of system including not limited to, information systems, financial systems, ecological systems, environmental systems, social systems, etc. Further, embodiments of the disclosed process are not limited to anomaly detection in computer system behavior. Accordingly, the process may be utilized for other applications, including but not limited to, detecting anomalies spot pricing, traffic flow, seismic activity, etc. It is contemplated that the process may be utilized to detect anomalous behavior in any type of system for which it is possible to collect a plurality of numeric measurements over time.

As used throughout the present disclosure, the term “performance metric” refers to a measurement related to the performance of computer system. Examples of performance metric s may include, but are not limited to, CPU usage, memory utilization, bytes written, bytes read, files read, files written, disk input/output (I/O) rate, number of instructions executed, number of transactions performed, throughput, response time, operating system (OS) dispatch activity metrics, locking metrics, network activity metrics, application-specific metrics, etc.

As used throughout the present disclosure, the term “bin” refers to a grouping or categorization of system data. Accordingly, system monitoring includes collecting and analyzing data related to system behavior, including but not limited to, computer system performance metrics. The process of binning includes categorizing system data into specific ranges or intervals, enabling analysis and visualization of system behavior. Further, the process of binning helps to identify patterns, anomalies, and trends in system behavior.

As used throughout the present disclosure the term “sample window” refers to a specific timeframe during which system data is collected and analyzed. A sample window represents a finite set of sequential system data samples or measurements taken at regular intervals. Further, the window size determines the duration or number of samples included within the sample window. For example, a sample window with a window size W equal to 10, means that the 10 intervals of time were sampled, resulting in 10 samples of system data. The window of samples can vary in duration depending on the monitoring requirements or the specific analysis being performed. For example, a window might be defined as a one-second interval, a five-minute interval, an hour long interval, etc. It is contemplated that a window may be defined by any interval.

As used throughout the present disclosure, the term “data series” refers to a collection of data points that are related to a specific system performance metric or parameter. Accordingly, a data series represents a set of values recorded over time for a particular aspect of system performance or behavior. A data series is typically organized in chronological order, with each data point corresponding to a specific point in time.

Illustrated embodiments include a process for monitoring system behavior. An embodiment includes a Multivariable Kullback-Leibler (MKL) based technique that enables assessment of anomalies in high dimensional data of unknown distribution. Accordingly, the process may utilize Kullback-Leibler (KL) divergence (also known as “entropy”) to find anomalies over a period of time. KL divergence may be used in part to measure similarity of a current observed situation and previous observations, with significant differences between the current situation and previous observations resulting in high entropy. Sufficiently high entropy may be interpreted as an anomaly. A period of time may range anywhere from fractions of a second to years. Further, assuming a system is non-chaotic, a system may be expected to execute a finite sets of tasks, e.g., transaction processing during the day, batch jobs at night, weekly, and monthly. A significant deviation from previously observed long-term behavior may be indicative of a problem requiring closer attention.

Illustrative embodiments include a continuous learning model for detecting anomalous system behavior. By continuously updating a set of historical observations to include new situations that were previously not observed, the model may mitigate false-positive detections of anomalous behavior in subsequent observations.

Illustrative embodiments include collecting data for multiple variables from a system. Each variable may include a monitored variable corresponding to a performance metric of a monitored system. Accordingly, illustrative embodiments include obtaining a data series corresponding to observed values for one or more monitored variables over a period of time. Further, the data series may be transformed into a probability distribution for the values of observed of each of the one or more variables. The probability distribution for each of the one or more variables may compared to one or more historical probability distributions corresponding to values previously observed for the one or more variables.

Illustrative embodiments include detecting an anomaly in system behavior based on a change in a historic correlation pattern between two or more variables. For example, the values of variable A and variable B may historically increase in lockstep with each other. If a scenario exists where the value of variable A increases but the value of variable B does not increase to the same degree as historically expected, or vice versa, then the process may detect an anomaly based on the correlation divergence between variable A and variable B.

Illustrative embodiments further include allocating a section of memory to store one or more historical observations in the form of a plurality of bins, the plurality of bins corresponding to a probability distribution of an associated data series collected for one or more monitored variables. Illustrative embodiments further may further include dividing each bin of the plurality of bins into sub-bins. Accordingly, the process enables a dynamic range for a probability distribution of values of one or more monitored variables.

Illustrative embodiments further include accounting for a missing data sample when sampling data corresponding to a monitored variable. It is contemplated that missing data may be part of the signal, and that a missing data sample or a pattern of missing data samples may be indicative of anomalous behavior in a system. Accordingly, the process enables keeping track of the percentage of missing data samples within each data series obtained from sampling the performance data of the system. Further, the probability distribution corresponding to the data series reflects the percentage of missing data samples in the data series.

Illustrative embodiments further include establishing a system performance database based at least in part on performance data received from a computer system. The system performance database may include a set of historical observations of performance of the computer system. Illustrative embodiments further include sampling current performance data from the computer system, generating a current observation based on the current performance data that was sampled, and comparing the current observation to each historical observation of the set of historical observations to determine a divergence between the current observation and each historical observation. Illustrative embodiments further include comparing each divergence to a divergence threshold, and upon a determination that any divergence exceeds the divergence threshold, detecting an anomaly in the computer system. Illustrative embodiments further include updating the set of historical observations to include the current observation as a new historical observation. Illustrative embodiments further include performing a responsive action within the computer system based on the anomaly that was detected.

For the sake of clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the data processing environments are used in the figures and the illustrative embodiments. In an actual computing environment, additional structures or components that are not shown or described herein, or structures or components different from those shown but for a similar function as described herein may be present without departing the scope of the illustrative embodiments.

Furthermore, the illustrative embodiments are described with respect to specific actual or hypothetical components only as examples. Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting to the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, computer readable storage media, high-level features, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

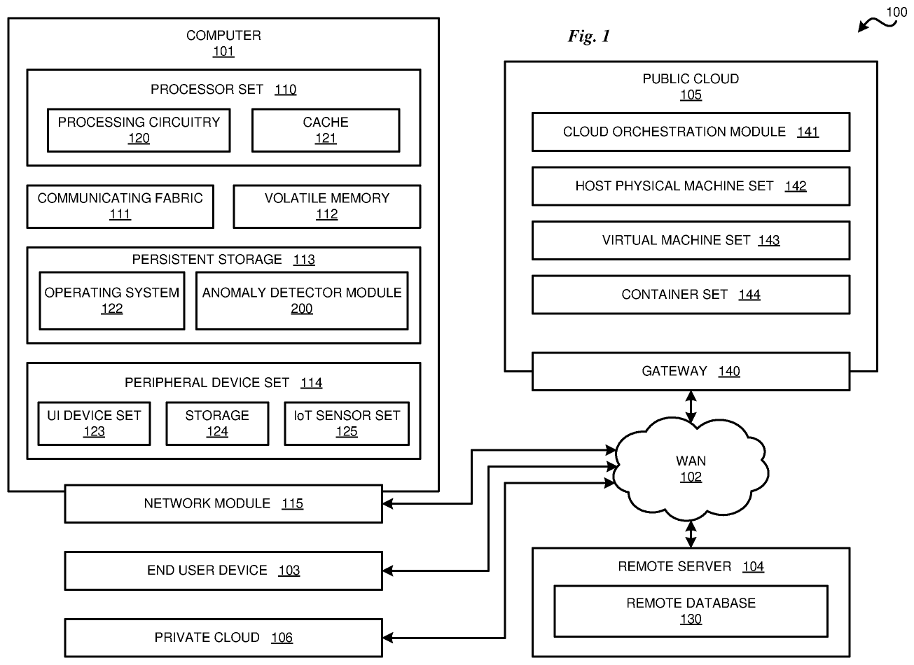

With reference to FIG. 1, this figure depicts a block diagram of a computing environment 100. Computing environment 100 contains an example of an environment for the execution of at least some of the computer code involved in performing the inventive methods, such as an anomaly detector module 200 that provides insights into a computer system's performance and historical behavior and provides responsive actions upon detection of an anomaly in the computer system's performance or behavior. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102.

Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Measured service: cloud systems automatically control and optimize resource use by leveraging a metering capability at some level of abstraction appropriate to the type of service (e.g., storage, processing, bandwidth, and active user accounts). Resource usage can be monitored, controlled, reported, and invoiced, providing transparency for both the provider and consumer of the utilized service.

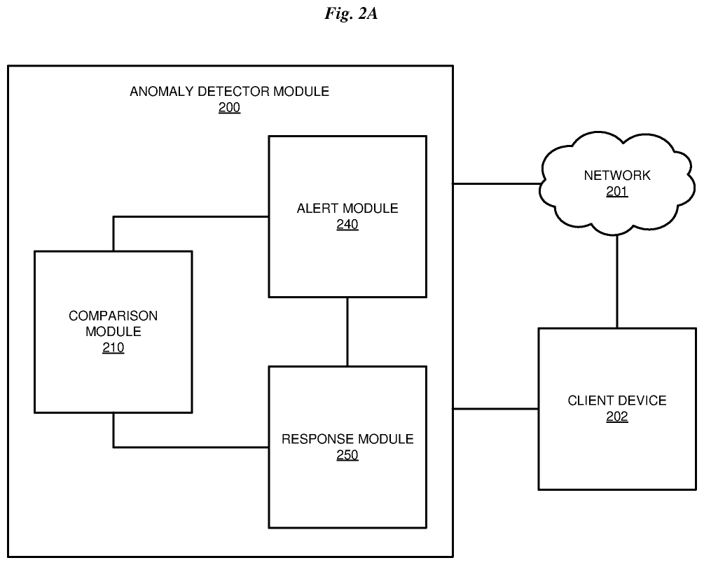

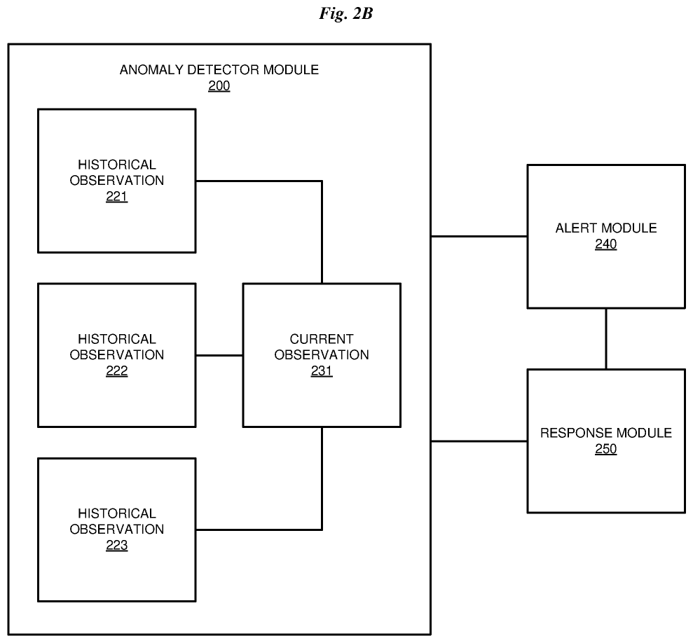

With reference to FIG. 2A, this figure depicts a block diagram of example computer system environment in accordance with an illustrative embodiment. In the illustrated embodiment, the system environment includes the anomaly detector module 200 of FIG. 1. Anomaly detector module 200 is configured to sample computer and/or network data from client device 202 and network 201. In an embodiment, anomaly detector module 200 exists at the operating system (OS) level. In an embodiment, data is sampled from operating system (OS) data. In the illustrated embodiment, the anomaly detector module 200 receives computer data from a client device 202 and/or network 201 and detects an anomaly in the data. The anomaly detector module 200 evaluates the monitored data for anomalies and generates an alert and/or responsive action in response to detected anomaly using example techniques described herein. In some embodiments, the anomaly detection module 200 detects anomalies by comparing a current observation of the system data to one or more historical observations. The comparison module 210 determines whether a value of an actual parameter associated with current observation exceeds a threshold value. In an embodiment, if the value of an actual divergence parameter associated with current observation exceeds a threshold divergence value, then the anomaly detector module 200 generates an alert via the alert module 240 and/or actuates a responsive action upon detection of an anomaly via the response module 250.

Client device 202 is depicted as a computer system. In an embodiment, the computer system includes a transaction-based mainframe computing system. An example of a transaction-based system may include, but is not limited to, a mainframe for credit card payments, a mainframe for bank transfers, a mainframe for airline reservations, a mainframe for insurance claims, etc. It is contemplated that transaction-based systems have a number of important considerations. Accordingly, transaction-based systems must be highly reliable, meaning that transaction-based system may have only a few seconds per year of unplanned downtime. Also, transaction-based systems mostly follow regular, but often complex patterns, which may also change on occasion. There are a number of problems that may need to be addressed to enable proper functioning of a system. These problems may be related to the performance of the system, security of the system, e.g., intrusions, inappropriate use of the system, as well as other areas, e.g., outlier in spot pricing in cloud market. While the process is described in relation to mainframes and with reference to certain industries, it is contemplated that the process may be utilized in other types of computer systems, other industries or fields of endeavor as well, as described herein. As a nonlimiting example, client device 202 may also include a super computer, mini computer, workstation computer, personal computer, server computer, analog computer, digital computer, hybrid computer, tablet, smartphone, personal digital assistant (PDA) and/or any other system and/or device that handles information and/or processes data. Embodiments of the network 201 include one or more of a variety of different types of networks having varying degrees of complexity. Embodiments disclosed herein describe network 201 within the context of an computer network; however, this is for descriptive purposes only and is not intended to be limiting.

With reference to FIG. 2B, this figure depicts a block diagram of the networking anomaly detector module 200 in accordance with illustrated embodiments. Comparison module 210 stores one or more historical observations, such as for example, historical observation 221, historical observation 222, and historical observation 223. A historical observation refers to a sample of computer data representative of usual operations taking place over a computer system. A historical observation may include values of monitored variables obtained over a predetermined number of intervals. In an embodiment, monitored variables include values of computer performance metrics. Further, the comparison module 210 compares the current observation 231 to each of historical observation 221, historical observation 222, and historical observation 223 to determine whether the current observation 231 matches any of historical observation 221, historical observation 222, and historical observation 223. The current observation 231 may include a probability distribution of values observed over a period of time in real-time. The historical observations 221, 222, 223 may each include a probability distribution of values observed historically over the computer system.

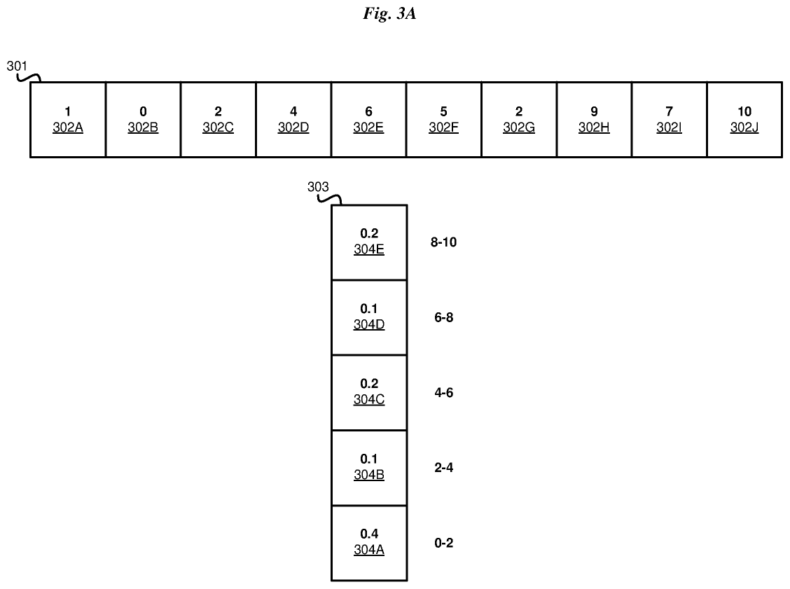

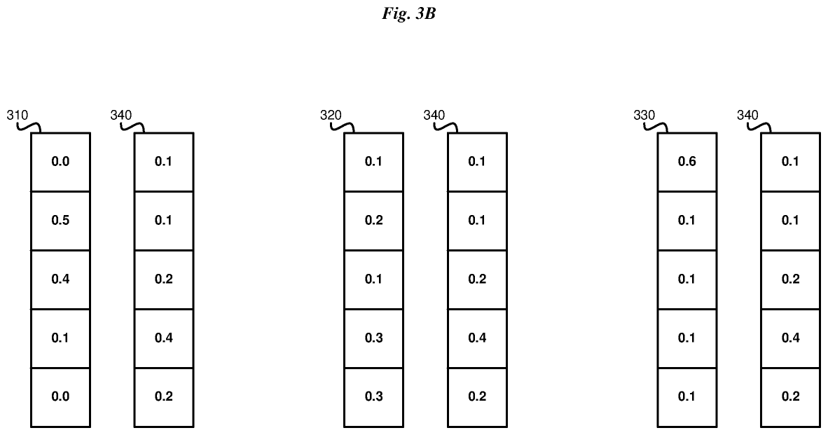

With reference to FIG. 3A, this figure depicts an example abstracted model of a probability distribution of events in accordance with illustrative embodiments. In an embodiment, an event corresponds to value of a particular data sample. Sample window 301 includes a plurality of data samples obtained over a period of time. In an embodiment, the data samples are computer system performance related data samples obtained from a computer system. Although the sample window 301 is depicted comprising 10 most recent samples obtained, it is contemplated herein that the sample window 301 may include any number of samples. Accordingly, each data sample, including data sample 302a, 302b, 302c, 302d, 302e, 302f, 302g, 302h, 302i, 302j, each contain a single data sample per interval of time. For example, if each interval is 1 second, then the sample window 301 is obtained over a period of 10 seconds. It is contemplated herein that the interval may be defined as any amount of time.

Further, with continued reference to FIG. 3A, probability distribution 303 defines how many of each data sample fall into a particular range. As depicted by FIG. 3A, the range of values of the plurality of data samples ranges from 0-10. Accordingly, the range for the data samples is 10, the minimum value (Min) is 0, and the maximum value (Max) is 10. The probability distribution may be determined by dividing the range by the number of bins of the plurality of bins that make up the probability distribution 303 to determine what percentage of the range should fall into each bin.

As depicted in FIG. 3A, the plurality of bins 303 includes 5 bins, including a first bin 304a, a second bin 304b, a third bin 304c, a fourth bin 304d, and a fifth bin 304e. Although the plurality of bins 303 includes 5 bins, it is contemplated that any number of bins may be defined. The range for the first bin 304a may be defined as: [Min-Max*0.2]. The range for the second bin 304b may be defined as: [Max*0.2-Max*0.4]. The range for the third bin 304c may be defined as: [Max*0.4-Max*0.6]. The range for the fourth bin 304d may be defined as: [Max*0.6-Max*0.8]. The range for the fifth bin 304e may be defined as: [Max*0.8-Max]. Accordingly, probability distribution 303 represents a probability distribution of values contained in sample window 301. Accordingly, the first bin 304a represents the fraction of samples in the sample window 301 are in the bottom 20% of the range, the second bin 304b represents the fraction of samples in the sample window 301 are between 20-40% of the range, and so forth.

In an embodiment, the process determines an anomaly in part by comparing the KL divergence between a probability distribution of a current observation and a historical observation to a chi-squared comparison. In an embodiment, where there are multiple historical observations, if the minimum KL is less than the chi-squared distribution, then the process detects an anomaly. The process for detecting an anomaly may be performed in the following example manner. The process calculates the KL divergence between the probability distribution of the current observation to each probability distribution of each historical observation. Accordingly, KL divergence quantifies the difference between the current observation and each of the historical observations. The process further computes a chi-squared statistic using each KL divergence value. The chi-squared statistic may be calculated as the square of the KL divergence divided by a measure of uncertainty or sample size to provide a chi-squared distribution. In an embodiment, the confidence level threshold is 99%. In some other embodiments, the confidence level threshold is 95%. In some other embodiments, the confidence level threshold is 99.9%. It is contemplated that other confidence level thresholds may likewise be defined.

Further, the process to determine a probability distribution for data samples in a computer system may be accomplished as follows. First, the process constructs a sample window 301 from a data series of input sample data, e.g., 10 samples. Next, the process determines the fraction of the samples have a value in each of N bins, e.g., five bins. Next, the process compares the current probability distribution to historical probability distributions of data series. In an embodiment, comparison includes a chi-squared comparison, and if chi-squared indicates a statistically significant difference, then an anomaly is detected.

With reference to FIG. 3B, this figure depicts a set of historical probability distributions compared to a current probability distribution. Historical probability distribution 310, historical probability distribution 320, and historical probability distribution 330 each represent a historical probability distribution of a value of a monitored variable corresponding to a particular performance metric. Current probability distribution 340 represents a currently observed probability distribution of values of data samples observed over a period of time. The current probability distribution 340 may be compared to each of historical probability distributions 310, 320, 330 to determine the divergence between the current probability distribution 340 and each of historical probability distributions 310, 320, 330. The current distribution 340 may be added to the set of historical probability distributions if none of probability distributions 310, 320, 330 are such that an entropy of current distribution 340 with respect to each of probability distributions 310, 320, 330 is less than a predetermined entropy threshold.

In the scenario depicted in FIG. 3B, the set of historical probability distributions (historical distribution 310, 320, and 330) represents all of the distinct distributions observed historically for a plurality of corresponding data series. If the current distribution 340 does not match any historically observed distribution, then current distribution 340 may represent an anomaly. In an embodiment, to prevent a current distribution from being added to the set of historical distributions prematurely, a test condition may be included that includes observing a data series consistent with a current probability distribution that represents an anomalous probability distribution more than once. For example, the test condition may include observing a data series consistent with a suspected anomalous distribution on two or more separates occurrences.

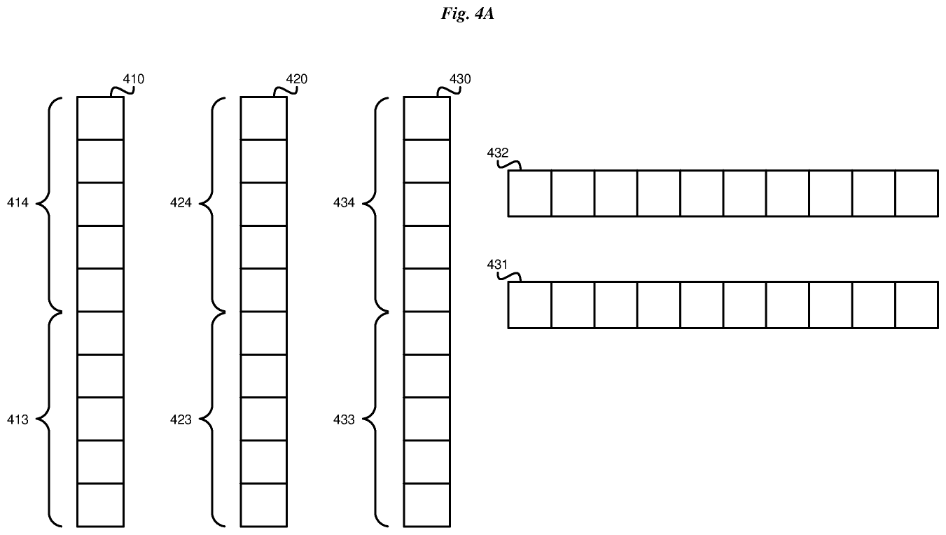

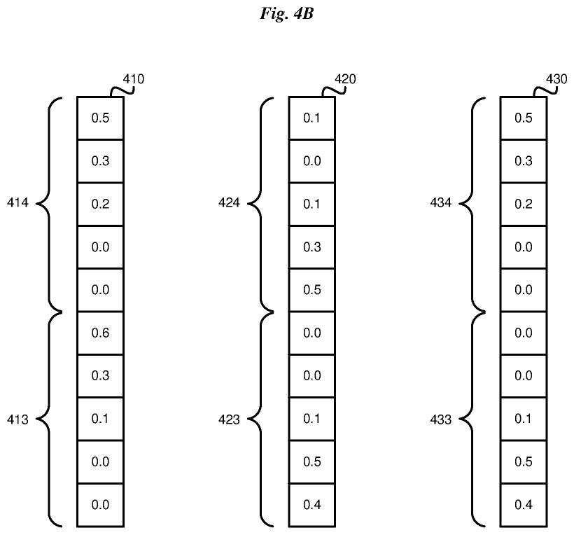

With reference to FIG. 4, this figure depicts an example abstracted model for determining a multivariable probability distribution of events in accordance with illustrated embodiments. The data structures representing the plurality bins 410, 420, and bin 430 are each example embodiments of the plurality of bins 303 depicted in FIG. 3A.

As shown in FIG. 4A, each observation includes plurality of bins stacked on top of each other. Accordingly, the process stacks the bins for each probability distribution obtained from individual data series of multiple variables, as illustrated. A first current data series 431 corresponds to a data series of the first variable obtained during a current observations, and a second current data series 432 corresponds to a data series of the second variable obtained during the current observation. Current observation 430 includes combined bins from a first current probability distribution 433 formed from the first current data series 431 and a second current probability distribution 434 formed from the second current data series 432. A first historical observation 410 includes bins corresponding to a first historical probability distribution 413 of a data series of a first variable combined with bins corresponding to a first historical probability distribution 414 of a data series of a second variable. A second historical observation 420 includes bins corresponding to a second historical probability distribution 423 of a data series of the first variable combined with bins corresponding to a second historical probability distribution 424 of a data series of the second variable. Stacking bins enables comparison of more than a single variable at a time, as describe in the present disclosure.

With continued reference to FIG. 4A, data series 431 corresponds to values of a first monitored variable observed over a period of time, and data series 432 corresponds to values of a second monitored variable observed over a period of time. In an embodiment, the process constructs a current observation 430 that includes a current probability distribution of each the of the first and second variable by stacking the bins associated with probability distribution 434 of the second variable 432 on top of the bins associated with probability distribution 433 of the first variable. Further, the process compares the current observation 430 of the combined first and second variable to each of historical observation 410 and historical observation 420 corresponding to the same first and second variables currently observed.

With reference to FIG. 4B, this figure depicts an abstracted model of a multivariable probability distributions of historical observed values of monitored variables, including example values for monitored variables corresponding to performance metrics of a system in accordance with illustrated embodiments. As a non-limiting example, suppose the first monitored variable may be a metric corresponding to CPU utilization, while the second monitored variable may be a metric corresponding to internal locking behavior of a system. As shown in FIG. 4B, the probability distribution 414 of the second variable contained in the first historical observation 410 matches the probability distribution 434 of the second variable contained in the current observation 430. Further, as shown in FIG. 4B, the probability distribution 423 of the first variable contained in second historical observation 420 matches the probability distribution 433 of the first variable contained in the current observation 430. However, as shown in FIG. 4B, the probability distribution of the first and second variables contained in the first historical observation 410 and the second historical observation 420 are shown to exhibit a correlation pattern, and that correlation pattern between the first and second variable diverges in the current observation 430. Although the probability distribution 433 of the first variable and the probability distribution 434 of the second variable each individually match probability distribution 423 of the second historical observation 420 and probability distribution 414 of the first historical observation 410, respectively, since the relationship between the first variable and the second variable is diverges from the historical correlation pattern, the process may detect an anomaly based on the variables being out-of-correlation with each other. Accordingly, instead of comparing individual probability distributions corresponding to individual variables, the process may compare a multiple probability distribution corresponding to multiple variables. Although for the sake of simplicity only 2 variables are shown as being compared, it is contemplated that the process may compare any number of monitored variables. In an embodiment, a chi-squared comparison is performed to determine the overall divergence between multiple variables represented in probability distribution of multiple variables. Further, it is contemplated that if one variable is out of range, then the entire probability distribution may be affected, thus indicating the presence of a potential anomaly.

As another non-limiting example, suppose a scenario where the process monitors four variables, including variable V, variable W, variable X, variable Z. In the scenario, W may correspond to a metric related to CPU utilization, X may correspond to a metric related to locking behavior, X may correspond to network activity, and Z may correspond to a metric related to operating system dispatch activity. Accordingly, there may be historical correlation pattern observed between variables V, W, X, and Z. If there is a divergence observed between the current relationship between V, W, X, and Z, and the historically observed correlation pattern between V, W, X, and Z, then the process may signal that an anomaly has been detected in the behavior of the system.

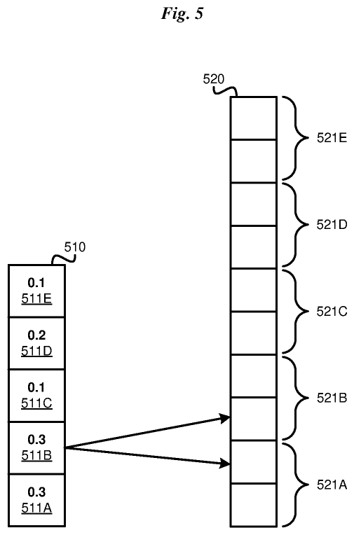

With reference to FIG. 5, this figure depicts a block diagram of an abstracted model of for updating a section of memory containing the range of values in a probability distribution in accordance with illustrated embodiments. As shown in FIG. 5, the original section of memory 510 includes an allocation of memory for 5 individual bins, bin 511a, bin 511b, bin 511c, bin 511d, and bin 511e. In the updated section of memory 520, each bin is shown subdivided into 2 sub-bins. Accordingly, new bins 521a, 521b, 521c, 521d, 521e, each include 2 sub-bins. It is contemplated that re-partitioning the original section of memory 510 into the new partitioned section of memory 520 enables for a more granular probability distribution of events. As shown in FIG. 5, the probability distribution for an event categorized in original bin 511b is divided between new bin 521a and new bin 521b in the new partition 520. Accordingly, the process assigns a data series into 5 initial bins. However, if a new data sample exceeds the previous range of the initial 5 bins, then the initial 5 bins may be further divided into sub-bins. In a scenario where each bin comprises 16 sub-bins, the total amount of bins is increased to 80 bins rather than 5 bins. The increased amount of bins allows for greater precision with regard to the probability distribution of the data series corresponding to the data sample.

Accordingly, each bin may be divided into sub-bins. Dividing each bin into sub-bins enables a dynamic range for data sampled from the system. It is contemplated that in certain scenarios, a data series of data samples obtained during sampling the performance data of the system may contain a data sample that is significantly different than previously observed data samples. Accordingly, it may be the case that historically a data series comprises a range with a maximum value of 1,000. If during sampling a data series is collected that comprises a new maximum value that is much greater than the historic maximum value, e.g., a new maximum value of 4,000, then that outlier data sample may cause a probability distribution contained in 5 bins to become highly skewed as a result. By sub-dividing each bin into sub-bins, an outlier data sample may still be collected that does not skew the probability distribution with respect to the remainder of the values in that data series. For example, a probability distribution expressed in 5 bins means that 20% of the range of values in the data series is captured by each bin, whereas a probability distribution expressed in 80 total bins means that 1.25% of the total range of values in the data series is captured in each bin. It is contemplated the plurality of bins may be sub-divided into any number of sub-bins. In an embodiment, each of the 5 initial bins is divided into 16 sub-bins, creating a total of 80 bins. Further, it is contemplated that the greater the number of total bins enables a more precise comparison of probability distributions of between data series for a particular monitored variable. In an embodiment, the process initializes with 5 bins for a data series for a monitored variable. If a subsequent sampled data series for the monitored variable exceeds the minimum or maximum value of the range of the initial data series for that monitored variable, then the bins may be enlarged to cover the new range, and the process re-allocates values from initial bins to new bins which have been sub-divided to be enlarged.

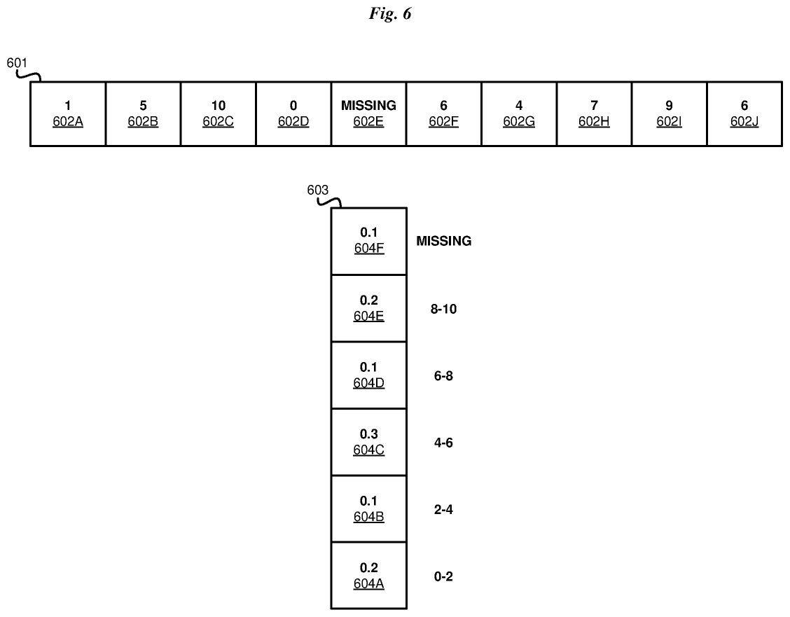

With reference to FIG. 6, this figure depicts a block diagram of an abstracted model of a section of memory partitioned to include an additional bin to account for one or more missing data samples in accordance with illustrative embodiments. It is contemplated herein that data collection may not always be perfect, and accordingly, sampling system data to form a data series may result in one or more missing data samples from the data series. In an embodiment, the process constructs an additional bin to account for one or more missing data samples. The probability distribution of a data series must always have a total sum equal to “1”, indicating that 100% of values fall somewhere within the range of the data series. Suppose a scenario where a data series contains 9 samples instead of 10. Instead of forming a probability distribution based on a data series comprising 9 data samples, the process stores the percentage of missing data samples into a bin designated to account for the percentage of missing data samples in the data series.

With continued reference to FIG. 6, data series 601 is shown missing a value for data sample 602e. As depicted in the figure, probability distribution 603 of data series 601 reflects missing data sample 602e by accounting for the missing data sample in a missing data sample bin 604f. The remainder of values of data series 601, including data samples 602a, 602b, 602c 602d, 602f, 602g, 602h, 602i, and 602j, are contained in the bins 604a, 604b, 604c, 604d, and 604e. It is contemplated that a missing data sample in a data series may be indicative of a pattern. By allocating a separate bin to account for missing data samples, the percentage of missing data samples may be tracked to determine whether the amount of missing data samples is indicative of anomalous system behavior. It is contemplated that the missing data sample bin 604f may account for a percentage of any number of data samples missing from data series. For example, in a scenario where the data series is missing 3 data samples out of a data series for 10 samples, then the missing sample bin 604f would account for 30% of data samples as missing data samples, and the remaining 70% of data samples would be distributed between bins 604a, 604b, 604c, 604d, and 604e. Accordingly, the missing data sample bin 604f may account for any percentage of missing data samples.

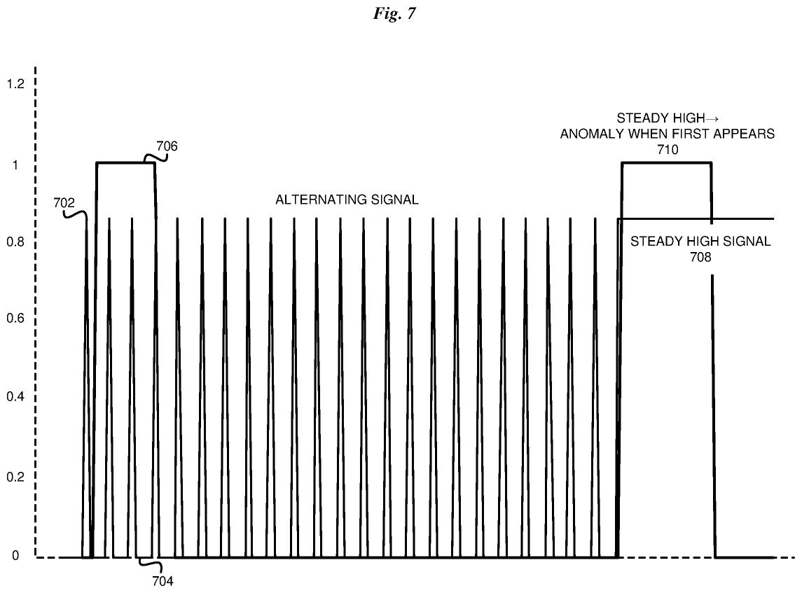

With reference to FIG. 7, this figure depicts a graph of an example process for detecting anomalous behavior in a computer system. As shown in the graph, the signal alternates between a high signal 702 and a low signal 704. When the process samples the signal during a first initial sampling period 706, the signal is determined to be alternating between a high 702 and a low signal 704 as expected. However, when the signal is sampled at a subsequent sampling period 710, the signal is shown exhibiting a steady state high signal 708, in which case the process detects an anomaly in the behavior of the system. Accordingly, the process may detect an anomaly in system behavior even when the range of a monitored variable is within a historical range, since the sampling data would indicate the current data sampled is not consistent with expected distribution of historical data sampled over a period of time.

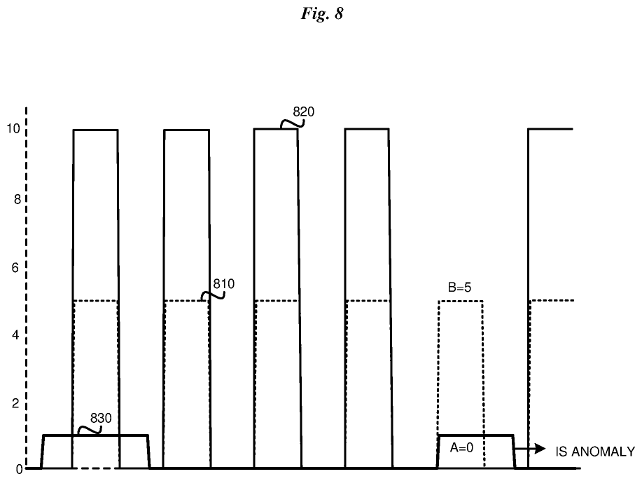

With reference to FIG. 8, this figure depicts a graph of an example process for detecting anomalous behavior in a computer system. As shown in the figure, a signal of a first variable 810 exhibits a correlation pattern with a signal of a second variable 820. The anomaly detector detects an anomaly when the signal of the first variable 810 is out of correlation with the signal of the second variable 820. As depicted in FIG. 8, the signal of the first variable 810 is expected to have a value of 5 while the signal of a second variable is expected to have a value of 10. The anomaly detector produces an anomaly detection signal 830 upon detecting that the signal of the first variable 810 is out of the correlation with the signal of the second variable 820.

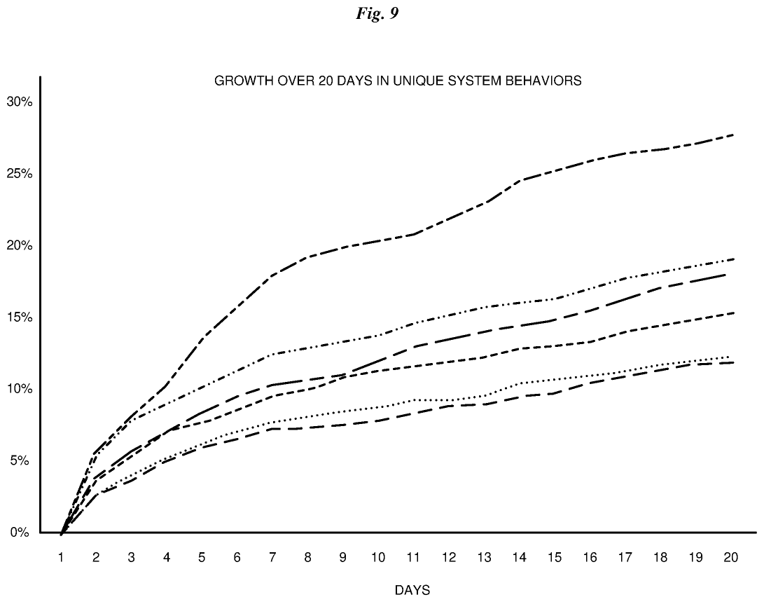

With reference to FIG. 9, this figure depicts a graph illustrating growth of unique system behaviors detected by an example process for detecting anomalous behavior in a computer system over a period of time in accordance with illustrated embodiments. As depicted in FIG. 9, the period of time depicted in the graph is a period of 20 days. Accordingly, since the process continuously learns from new observations, the number of unique observations decreases over time.

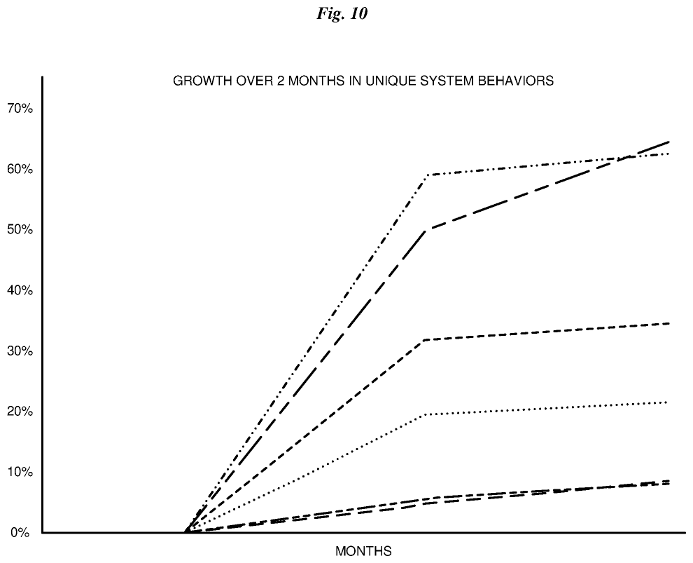

With reference to FIG. 10, this figure depicts a graph of a historical unique system behaviors detected by an example process for detecting anomalous behavior in a computer system over a period of months in accordance with illustrated embodiments. As depicted in FIG. 10, the period of time depicted in the graph is a period of 2 months. As similarly depicted by FIG. 9, the number of unique observations decreases over time. Accordingly, in an embodiment, after a period of approximately 2 months, very few unique observations are detected compared to during the initialization period of the process.

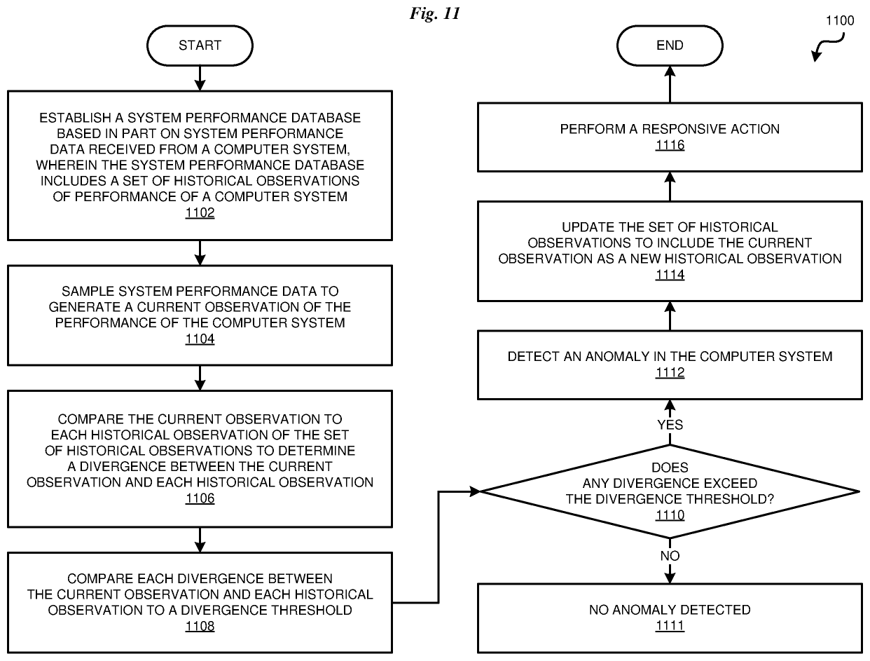

With reference to FIG. 11 this figure depicts a flowchart of an example process 1100 for detection of an anomalous system behavior and performance of a responsive action based on the detected anomaly in accordance with an illustrative embodiment. In a particular embodiment, the anomaly detector module 200 of FIGS. 1 and 2A-2B carries out the process 1100.

In the illustrated embodiment, at block 1102, the process establishes a system performance database based in part on system performance data received from a computer system. The system performance database may include a set of historical observations of performance of the computer system. Each historical observation of the set of historical observations may include of a probability distribution of a value of a monitored variable across a data series collected by sampling the computer system performance data over a period of time. The monitored variable may include a performance metric related to the performance of the computer system. The probability distribution may be stored in a plurality of bins, wherein each bin contains a percentage of the values of the monitored within a certain range of the probability distribution. Although the process is described with reference to performance data and performance of a computer system, it is contemplated that the process may likewise be adapted without significant modification to encompass any behavior data related to system behavior of any system.

At block 1104, the process samples performance data from the computer system to generate a current observation of the performance of the computer system. Accordingly, the process may sample current performance data, where current performance data refers to a most recent data series of a variable collected from sampling the system data. In an embodiment, current performance data is sampled in real-time. The current observation may include a probability distribution of a value of a monitored variable that was sampled. At block 1106, the process compares the current observation to each historical observation of the set of historical observations to determine a divergence between the current observation and each historical observation. In an embodiment, the divergence between the current observation and each of the historical observations is determined using a KL divergence technique. In an embodiment, current observation and each historical observation include a probability distribution for one or more monitored variables. In an embodiment, the process performs a multivariable divergence analysis between the current observation and each historical observation.

In an embodiment, the process further determines a historical correlation pattern between two or more variables of each of the historical observations. Further, the process determines whether the values of the one or more variables are out-of-correlation to each other with respect to the historical correlation pattern between the two or more variables. Upon a determination that the two or more variables are out-of-correlation to each other, the process may detect an anomaly.

At block 1108, the process compares each divergence between the current observation and each historical observation to a divergence threshold. At block 1110, the process determines whether any calculated divergence exceeds the divergence threshold. If a determination is made that no calculated divergence exceeds the divergence threshold, then at block 1111 the process determines that no anomaly is detected. If a determination is made that a calculated divergence exceeds the divergence threshold, then at block 1112 the process detects an anomaly in the computer system.

At block 1114, the process updates the set of historical observations to include the current observation as a new historical observation. Accordingly, during a subsequent iteration of the process, the process will not detect an anomaly based on a current observation that resembles an observation that has been previously observed. Further, by updating the set of historical observations to include observations that have once been detected to be anomalous behavior, the process provides a model that continuously learns system behavior.

At block 1116, the process performs a responsive action based the anomaly that has been detected. In an embodiment, performing a responsive action includes generating, sending, and/or displaying an alert related to the anomaly on an interface. Accordingly, the process may generate a real-time alert or notifications and send the alert to the device of an administrator, operators, or other relevant person or entity detailing the detected anomaly. In some embodiments, the alert is sent to the computer system being monitored, an external monitoring device, or both. The alert may be sent in various mediums, including but not limited to, email, SMS, or through a dedicated monitoring interface. In an embodiment, performing a responsive action includes logging relevant anomaly details, including but not limited to, timestamps, error codes, and contextual information. The logs generated may be utilized in a subsequent analysis to identify root causes and prevent future occurrences.

In an embodiment, performing a responsive action includes initiating a recovery procedure to rectify the anomaly. For example, the recovery procedure may include, but is not limited to, attempting to restart a failed process, restoring data from a backup, or reconfiguring one or more components to restore normal operation. In an embodiment, performing a responsive action includes balancing the system load and/or re-allocating computer resources. For example, if an anomaly is related to resource utilization, the process may dynamically adjust resource allocation and/or trigger a load balancing mechanism, thereby distributing workload evenly and optimizing resource usage to mitigate the impact of the anomaly. In an embodiment, performing a responsive action includes adjusting a configuration of the computer system. Accordingly, an anomaly may indicate the need for adjustments in a system configuration, threshold, or parameter. The process may initiate a predefined corrective action, including but not limited to, adjusting memory allocation, or tuning resource usage to optimize performance and/or stability.

In an embodiment, performing a responsive action includes isolating a portion of a computer system and/or network, such as an affected component, network, or user account to prevent further damage or unauthorized access. Further, isolating a portion of a computer system and/or network may include blocking network traffic, suspending a user session, or placing affected components in a restricted environment for investigation. In an embodiment, performing a responsive action includes activating a failover mechanism to switch to redundant or backup components, which enables uninterrupted operation and minimizes downtime or service disruptions.

Although the process depicted by FIG. 11 has been described with reference to a computer system, it is contemplated that the process may be utilized to detect anomalous behavior in any type of system for which it is possible to collect a plurality of numeric measurements over time. Nonlimiting examples of other systems that the process may be used in conjunction with may include, but are not limited to, systems related to spot pricing, traffic monitoring, quality control inspection, the search for extra-terrestrial intelligence (SETI), and any other system for which system behavior may be sampled, observed, monitored, and/or analyzed to detect anomalous behavior of the system.

In some embodiments, the process may be adapted for and/or directed towards a spot pricing application. Accordingly, the process may detect an anomaly in spot pricing for any asset or service. Spot price refers to the current price in a marketplace at which a given asset or service may be bought or sold for immediate delivery, which may be specific to both time and place. In some such embodiments, process may be adapted for and/or directed towards spot pricing for cloud instances. A cloud instance refers to a virtual server that may be utilized to run an application. Cloud instances are typically provisioned according to the needs of a user and may be upgraded or downgraded with cloud software. Cloud instances may be created in multiple geographical regions throughout the world. Further, cloud instances may be created and/or terminated on demand. It is contemplated that one or more cloud instances may be utilized to execute one or more tasks and/or any combination of tasks. Further, multiple cloud instances may be grouped to execute one or more tasks. In some such embodiments, the process adjusts usage of cloud instances. In some such embodiments, the process may compare one or more historical observations of spot pricing and resource usage, and upon the detection of an anomaly, the process may adjust the usage of one or more cloud instances based on the anomaly detected in spot pricing behavior. Nonlimiting examples of a responsive action performed upon the detection of an anomaly in spot pricing behavior may include, but are not limited to, upgrading a cloud instance, downgrading a cloud instance, creating an additional cloud instance, and/or terminating an existing cloud instance. It is contemplated that adjusting the usage of one or more cloud instances based on detection of an anomaly in spot pricing behavior may enable preventing unnecessary expenditure of computer resources. Although spot pricing has been described with reference to cloud storage, it is contemplated that the process may be utilized to detect anomalous behavior in any system related to spot pricing.

In some embodiments, the process may be adapted for and/or directed towards a traffic monitoring system. Traffic monitoring, also known as network monitoring, refers to observing and analyzing incoming and outgoing traffic on a computer network. Accordingly, in some such embodiments, the process may compare one or more historical observations of network traffic behavior to a current observation of network traffic behavior to detect anomaly in network traffic behavior. Nonlimiting examples of a responsive action performed upon the detection of an anomaly in traffic behavior may include, but are not limited to, adjusting the traffic flow of the network, isolating a segment of the network where the specific anomaly was detected, disconnecting a potentially compromised device, disabling a network port, blocking an IP address, resetting a password for a user account, removing malware, deleting a file, restoring a file, reimaging a device, and/or generating a report to display on an interface.

In some embodiments, the process may be adapted for and/or directed towards a quality control inspection system. In the context of quality control inspection, an inspection refers to an activity such as measuring, examining, testing and/or gauging one or more characteristics of a product and comparing the results with specified requirements in order to establish whether conformity is achieved for each characteristic. Accordingly, in some such embodiments, the process may compare one or more historical observations related to quality control a current observation related to quality control of to detect anomaly related to behavior related to a quality control inspection system. Nonlimiting examples of a responsive action performed upon the detection of an anomaly in quality control may include, but are not limited to removing a product or product part from production, adjusting a manufacturing control parameter, (e.g., temperature, pressure, etc.), and/or generating a report to display on an interface.

In some embodiments, the process may be adapted for and/or directed towards a system related to the Search for Extraterrestrial Life (SETI). The Search for Extraterrestrial Intelligence (SETI) is a collective term that refers to scientific searches for intelligent extraterrestrial life. In some embodiments, an SETI system may include monitoring electromagnetic radiation (e.g., radio waves) for signs of transmissions from civilizations on other planets. It is contemplated that human endeavors emit considerable electromagnetic radiation into outer space as a byproduct of communications such as television and radio, which may be easily recognizable as artificial due to the signals repetitive nature and/or narrow bandwidths. Further, Earth has been sending radio waves from broadcasts into space for over 100 years, and these signals have reached over 1,000 stars. If intelligent alien life exists on any planet orbiting these stars, these signals could be heard and deciphered by said intelligent alien life. Further, if signals are detected in outer space that differ from the signals that have been emitted by humans into outer space, these signals may be indicate origination from an intelligent alien life. Accordingly, in some such embodiments, the process may detect anomalies in electromagnetic radiation monitored in outer space. Further, in some such embodiments, the process may be used to detect radio signals that are different from background noise, which may be indicative of intelligent origin. Accordingly, the process may compare a current observation of radio waves to one or more historical observations of radio waves to detect an anomalous radio wave. Further, in some such embodiments, an anomalous radio wave may be further examined to determine whether the anomalous radio wave suggests intelligent origin. Nonlimiting examples of responsive actions that may be performed upon detection of an anomalous radio wave may include, but are not limited to, sending a response signal encoded with information to the location of where the anomalous signal was detected, and/or generating a report to display on an interface.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

What is claimed is:

1. A computer-implemented method comprising:
establishing a system behavior database based at least in part on behavior data received from a system, wherein the system behavior database comprises a set of historical observations of behavior of the system;
sampling current behavior data from the system;
generating a current observation based on the current behavior data that was sampled;
comparing the current observation to a subset of the set of historical observations of the set of historical observations to determine a divergence between the current observation and the subset of historical observation;
comparing the divergence to a divergence threshold; and
upon a determination that the divergence exceeds the divergence threshold:
detecting an anomaly in the system;
updating the set of historical observations to include the current observation as a new historical observation; and
performing a responsive action within the system based on the anomaly that was detected.

2. The computer-implemented method of claim 1, further comprising detecting a correlation pattern between two or more monitored variables of the set of historical observations, and upon a determination that the current observation comprises the two or more variables out-of-correlation with respect to each other, detecting an anomaly in the system.

3. The computer-implemented method of claim 1, wherein performing the responsive action comprises generating an anomaly detection report to display on an interface.

4. The computer-implemented method of claim 1, wherein the system is a computer system, and wherein performing the responsive action comprises isolating a section of the computer system based on the anomaly that was detected.

5. The computer-implemented method of claim 1, wherein the system is a computer system, and wherein performing the responsive action comprises activating a redundant component to handle a portion of operations performed over the computer system.

6. The computer-implemented method of claim 1, wherein the system is a computer system, and wherein performing the responsive action comprises reconfiguring a component of the computer system to restore the computer system to normal operation.

7. The computer-implemented method of claim 1, wherein the system is a computer system, and wherein performing the responsive action comprises allocating computer resources to evenly distribute a workload across the computer system.

8. The computer-implemented method of claim 1, wherein each historical observation and the current observation comprise a probability distribution of a value of a variable associated with system behavior.

9. The computer-implemented method of claim 1, wherein sampling the current behavior data from the system comprises collecting one or more samples of system behavior data over a period of time.

10. The computer-implemented method of claim 1, further comprising allocating a portion of memory to store the current observation and each historical observation and partitioning each portion of memory into a plurality of bins, wherein each bin of the plurality of bins corresponds to a percentage of data samples that fall within a particular range of values.

11. The computer-implemented method of claim 10, further comprising expanding each bin of the plurality of bins upon sampling data that is outside of the particular range of values.

12. The computer-implemented method of claim 10, further comprising constructing a missing data sample bin that corresponds to a percentage of missing data samples.

13. A computer program product comprising one or more computer readable storage media, and program instructions collectively stored on the one or more computer readable storage media, the program instructions executable by a processor to cause the processor to perform operations comprising:
establishing a system behavior database based at least in part on behavior data received from a system, wherein the system behavior database comprises a set of historical observations of behavior of the system;
sampling current behavior data from the system;
generating a current observation based on the current behavior data that was sampled;
comparing the current observation to a subset of the historical observations of the set of historical observations to determine a divergence between the current observation and the subset historical observations;
comparing the divergence to a divergence threshold; and
upon a determination that the divergence exceeds the divergence threshold:
detecting an anomaly in the system;
updating the set of historical observations to include the current observation as a new historical observation; and
performing a responsive action within the system based on the anomaly that was detected.

14. The computer program product of claim 13, wherein the stored program instructions are stored in a computer readable storage device in a data processing system, and wherein the stored program instructions are transferred over a network from a remote data processing system.

15. The computer program product of claim 13, wherein the stored program instructions are stored in a computer readable storage device in a server data processing system, and wherein the stored program instructions are downloaded in response to a request over a network to a remote data processing system for use in a computer readable storage device associated with the remote data processing system, further comprising:
program instructions to meter use of the program instructions associated with the request; and
program instructions to generate an invoice based on the metered use.

16. The computer program product of claim 13, further comprising detecting a correlation pattern between two or more monitored variables of the set of historical observations, and upon a determination that the current observation comprises the two or more variables out-of-correlation with respect to each other, detecting an anomaly in the system.

17. The computer program product of claim 13, further comprising allocating a portion of memory to store the current observation and each historical observation and partitioning each portion of memory into a plurality of bins, wherein each bin of the plurality of bins corresponds to a percentage of data samples that fall within a particular range of values.

18. A computer system comprising a processor and one or more computer readable storage media, and program instructions collectively stored on the one or more computer readable storage media, the program instructions executable by the processor to cause the processor to perform operations comprising:
establishing a system behavior database based at least in part on behavior data received from a system, wherein the system behavior database comprises a set of historical observations of behavior of the system;
sampling current behavior data from the system;
generating a current observation based on the current behavior data that was sampled;
comparing the current observation to a subset of the historical observations of the set of historical observations to determine a divergence between the current observation and the subset historical observations;
comparing the divergence to a divergence threshold; and
upon a determination that the divergence exceeds the divergence threshold:
detecting an anomaly in the computer system;
updating the set of historical observations to include the current observation as a new historical observation; and
performing a responsive action within the system based on the anomaly that was detected.

19. The computer system of claim 18, further comprising detecting a correlation pattern between two or more monitored variables of the set of historical observations, and upon a determination that the current observation comprises the two or more variables out-of-correlation with respect to each other, detecting an anomaly in the system.

20. The computer system of claim 18, further comprising allocating a portion of memory to store the current observation and each historical observation and partitioning each portion of memory into a plurality of bins, wherein each bin of the plurality of bins corresponds to a percentage of data samples that fall within a particular range of values.
